(19) United States
(12) Patent Application Publication
(10) Pub. No.: US 2026/0328559 A1
(43) Pub. Date: Oct. 22, 2026

(54) PORTABLE OPTICAL THREAD-PROFILING SYSTEM AND METHOD

(71) Applicant: Autonetics LLC, Moncure, NC (US)

(72) Inventor: Christopher V. Wezyk, Pittsboro, NC (US)

(21) Appl. No.: 19/389,627

(22) Filed: Nov. 14, 2025

(51) Int. Cl. G01B 11/24; G01B 11/03; G01B 11/25; G01D 7/00

(52) U.S. Cl. CPC G01B 11/2425; G01B 11/03; G01B 11/2504; G01B 11/2518; G01D 7/002

(57) ABSTRACT

The present disclosure provides a portable optical thread-profiling system comprising a clamping assembly configured to clamp an end portion of a pipe having a threaded region, a movement stage above the outer surface of the pipe, and hardware processors configured for performing a measurement pass to measure a thread profile of the pipe. The movement stage includes a moveable observation platform with first and second spectrometers disposed at forward and rearward angles relative to the outer surface of the pipe, a drive mechanism for translating the observation platform, a displacement sensor for measuring position of the observation platform, and a calibration feature aligned with an optical measurement path of both spectrometers. Hardware processors direct a measurement pass, perform a calibration routine, and receive coordinate and position data to determine a thread profile of the threaded region.

### TECHNICAL FIELD

The present disclosure relates to portable measurement systems for evaluating threaded connections, and more particularly to portable optical systems utilizing dual spectrometers and integrated calibration features for measuring thread profiles of Oil Country Tubular Goods with micron-level accuracy.

### BACKGROUND

Oil Country Tubular Goods (OCTG) refers to the steel tubular products used in oil and gas operations, including drill pipe, casing, and tubing. These pipes employ standardized and premium threaded connections that must mate precisely to maintain seal integrity, transmit loads, and avoid non-productive time. The threaded connections are manufactured to exacting tolerances, and accurate measurement of thread profiles is fundamental to ensuring proper connection performance in downhole environments.

Traditional approaches for assessing the profile of internal threads include replica casting methods, where a metrology-grade material is introduced into the threaded region, allowed to cure, removed, sectioned, and then evaluated on an optical comparator against a theoretical overlay. While widely used in the industry, this process is time-consuming and depends heavily on operator skill and judgment for accurate interpretation of results.

Another common approach involves mechanical gauging and stylus profile checks in accordance with industry standards, including use of plug and ring gauges and thread-profile templates to verify tooth form and dimensions. These methods require setup time and can be susceptible to wear or fragility of contact tools. Additionally, manual interpretation of results introduces variability and potential for human error in the assessment process.

More recent practices employ non-contact optical systems using laser or vision technology to measure thread geometry. These systems aim to reduce subjectivity and accelerate inspection processes compared to traditional methods. Some vendors now apply digital imaging or automated analysis to flag defects, representing an advancement over purely manual assessment techniques.

However, existing measurement systems face several challenges in practical field applications. Many optical measurement devices lack portability, requiring pipes to be brought to fixed measurement stations rather than allowing measurement at the point of use. This limitation can create logistical difficulties and delays in inspection workflows, particularly in field operations where mobility is advantageous.

Current optical measurement systems also face accuracy challenges when measuring complex thread geometries. Thread profiles can include steep flank angles, varying surface finishes, and intricate geometries that can be difficult to measure consistently with existing optical triangulation methods. Surface reflectivity variations and debris in thread roots can interfere with optical measurements, leading to inconsistent or inaccurate results.

Calibration and setup procedures for existing measurement systems can be complex and time-consuming. Many systems require extensive calibration procedures that must be performed by trained technicians, and the calibration may drift over time or with environmental changes. This complexity can limit the practical deployment of measurement systems in field environments where simplicity and reliability are valued.

Therefore, there exists a need for improved systems and methods to measure thread profiles of OCTG pipes that address these limitations while providing reliable, repeatable assessments in a field environment.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In an embodiment, a portable optical thread-profiling system is disclosed. The portable optical thread-profiling system comprises a clamping assembly configured to engage a portion of a pipe having a threaded region. The portable optical thread-profiling system further comprises a movement stage disposed above an outer surface of the pipe when the portion of the pipe is engaged by the clamping assembly. The movement stage comprises a moveable observation platform configured to translate along a longitudinal axis of the threaded region of the pipe. The observation platform comprises a first optical sensor disposed along the longitudinal axis at a forward angle relative to the outer surface of the pipe. The observation platform further comprises a second optical sensor disposed along the longitudinal axis at a rearward angle relative to the outer surface of the pipe. The observation platform further comprises a displacement sensor configured to measure a position of the observation platform along the longitudinal axis. The movement stage further comprises a drive mechanism configured to translate the observation platform along the longitudinal axis.

In various embodiments, the portable optical thread-profiling system further comprises one or more hardware processors configured for performing a measurement pass to measure a thread profile of the threaded region of the pipe. The measurement pass comprises directing translation of the observation platform along the longitudinal axis. The measurement pass further comprises receiving raw optical measurement data from the first optical sensor and the second optical sensor during the translation of the observation platform. The measurement pass further comprises receiving position data of the observation platform from the displacement sensor during the translation of the observation platform. The measurement pass further comprises determining a thread profile of the threaded region of the pipe based on the received raw optical measurement data, the received position data, and calibration data for the first optical sensor and the second optical sensor.

In various embodiments, wherein the one or more hardware processors are further configured for converting the raw optical measurement data from the first optical sensor and the second optical sensor into coordinate data in an (x, y) format.

In various embodiments, the raw optical measurement data from the first optical sensor is a numerical value that represents a distance from the first optical sensor to the surface of the pipe along an optical axis of the first optical sensor, and the raw optical measurement data from the second optical sensor is a numerical value that represents a distance from the second optical sensor to the surface of the pipe along an optical axis of the second optical sensor.

In various embodiments, the one or more hardware processors are further configured for comparing the determined thread profile against one or more expected parameters of the threaded region of the pipe.

In various embodiments, the calibration data for the first optical sensor and the second optical sensor is determined based on a calibration routine performed using a calibration feature.

In various embodiments, the one or more hardware processors are further configured for determining, based on the received raw optical measurement data, the received position data, and calibration data, one or more of the following values for the threaded region of the pipe: load lead value, load thread height value, root step height value, root-crest parallelism value, seal profile value, stab lead value, stab thread height value, thread profile value, thread width location, and wedge health (measured as a percentage) for one or more scans.

In various embodiments, the movement stage further comprises a calibration feature aligned with an optical measurement path of the first optical sensors and the second optical sensor.

In various embodiments, the calibration feature comprises a known thread pattern that allows the system to determine an angle of the first optical sensor and the second optical sensor during the measurement pass.

In various embodiments, the portable optical thread-profiling system further comprises one or more hardware processors configured for performing a measurement pass to measure a thread profile of the threaded region of the pipe. The measurement pass comprises directing translation of the observation platform along the longitudinal axis. The measurement pass further comprises performing a calibration routine to determine calibration data for the first optical sensor and the second optical sensor as said optical sensors pass over the calibration feature during the translation of the observation platform. The measurement pass further comprises receiving raw optical measurement data from the first optical sensor and the second optical sensor during the translation of the observation platform. The measurement pass further comprises receiving position data of the observation platform from the displacement sensor during the translation of the observation platform. The measurement pass further comprises determining a thread profile of the threaded region of the pipe based on the received raw optical measurement data, the received position data, and the determined calibration data.

In various embodiments, the calibration routine is performed during each measurement pass.

In various embodiments, the clamping assembly comprises an internal clamping surface configured for insertion into the end portion of the pipe. The clamping assembly further comprises a clamping actuator configured for moving the internal clamping surface to engage an inner surface of the pipe.

In various embodiments, the first optical sensor and the second optical sensor are confocal spectrometer probes electronically coupled to a spectrometer controller by fiber optic cables.

In various embodiments, the forward angle of the first optical sensor is approximately 45° from perpendicular to the outer surface of the pipe, and the rearward angle of the second optical sensor is approximately 45° from perpendicular to the outer surface of the pipe, such that the first optical sensor and the second optical sensor are positioned approximately 90° relative to one another.

In various embodiments, the first optical sensor and the second optical sensor sample at a minimum frequency of 25 kHz.

In various embodiments, the displacement sensor comprises an optical encoder read head configured to read position data from an encoder strip on the movement stage.

In various embodiments, the portable optical thread-profiling system comprises a face assembly connected to the movement stage. The face assembly comprises a display panel.

In various embodiments, the movement stage further comprises a first rail and a second rail. The observation platform further comprises a first carriage and a second carriage. The first carriage slidably engages the first rail, and the second carriage slidably engages the second rail to allow for the observation platform to translate along the longitudinal axis.

In an embodiment, a method for measuring a thread profile of a pipe having a threaded region using a portable optical thread-profiling system is disclosed. The method comprises engaging an end portion of the pipe. The method further comprises directing translation of an observation platform of the portable optical thread-profiling system along a longitudinal axis of the threaded region of the pipe, wherein the observation platform comprises a first optical sensor disposed at a forward angle relative to an outer surface of the pipe and a second optical sensor disposed at a rearward angle relative to the outer surface of the pipe. The method further comprises receiving raw optical measurement data representing the thread profile from the first optical sensor and the second optical sensor during the translation of the observation platform. The method further comprises receiving position data of the observation platform from a displacement sensor of the portable optical thread-profiling system during the translation of the observation platform. The method further comprises determining a thread profile of the threaded region of the pipe based on the received raw optical measurement data, the received position data, and calibration data for the first optical sensor and the second optical sensor.

In an embodiment, a non-transitory computer-readable storage medium is disclosed. The non-transitory computer-readable storage medium stores instructions to be implemented on a portable optical thread-profiling device. The portable optical thread-profiling device comprises a clamping assembly configured to engage a portion of a pipe having a threaded region. The portable optical thread-profiling device further comprises a movement stage disposed above an outer surface of the pipe when the portion of the pipe is engaged by the clamping assembly. The movement stage comprises a moveable observation platform configured to translate along a longitudinal axis of the threaded region of the pipe. The observation platform comprises a first optical sensor disposed along the longitudinal axis at a forward angle relative to the outer surface of the pipe. The observation platform further comprises a second optical sensor disposed along the longitudinal axis at a rearward angle relative to the outer surface of the pipe. The observation platform further comprises a displacement sensor configured to measure a position of the observation platform along the longitudinal axis. The movement stage further comprises a drive mechanism configured to translate the observation platform along the longitudinal axis. The movement stage further comprises at least one hardware processor electronically connected to the portable optical thread-profiling device. The instructions when executed by the at least one hardware processor cause portable optical thread-profiling device to perform a measurement pass to measure a thread profile of the threaded region of the pipe. The measurement pass comprises directing translation of the observation platform along the longitudinal axis. The measurement pass further comprises receiving raw optical measurement data from the first optical sensor and the second optical sensor during the translation of the observation platform. The measurement pass further comprises receiving position data of the observation platform from the displacement sensor during the translation of the observation platform. The measurement pass further comprises determining a thread profile of the threaded region of the pipe based on the received raw optical measurement data, the received position data, and calibration data for the first optical sensor and the second optical sensor.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIGS. 1A-1B depict an example pipe for measurement with the portable optical thread-profiling system.

FIGS. 1C-1D depict cross-sectional views of the example pipe for measurement with the portable optical thread-profiling system.

FIG. 2 shows a perspective view of the portable optical thread-profiling system.

FIG. 3 shows a perspective view of the portable optical thread-profiling system with a pipe engaged.

FIG. 4 shows a top view of the portable optical thread-profiling system.

FIG. 5 shows a left-side view of the portable optical thread-profiling system.

FIG. 6 shows a right-side view of the portable optical thread-profiling system.

FIG. 7 shows a bottom view of the portable optical thread-profiling system.

FIG. 8A shows a view of the clamping portion of the portable optical thread-profiling system.

FIG. 8B shows a view of capacitive sensors that detect contact with the face of the pipe.

FIG. 9A shows a view of a displacement sensor on one carriage of the observation platform.

FIG. 9B shows a view of the pad holder and a pad.

FIG. 10 shows a view of the optical sensors of the portable optical thread-profiling system.

FIG. 11 shows a view of the drive mechanism for the observation platform.

FIG. 12 shows a view of the calibration feature of the movement stage.

FIG. 13 shows a view of the LED panel display system.

FIG. 14 shows the computing hardware implemented to provide measurement control and data processing.

FIG. 15 shows a graphical user interface on a remote computer.

FIG. 16 shows an example method for determining the thread profile using the portable optical thread-profiling system.

### DETAILED DESCRIPTION

It is an object of the present disclosure to provide improved systems and methods for measuring internal thread profiles of OCTG pipes that provide reliable, repeatable assessments in both laboratory and field environments.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description to provide a thorough understanding of the embodiments disclosed herein, some embodiments can be practiced without some or all of these details. Moreover, for the purpose of clarity, certain technical material that is known in the related art has not been described in detail to avoid unnecessarily obscuring the disclosure.

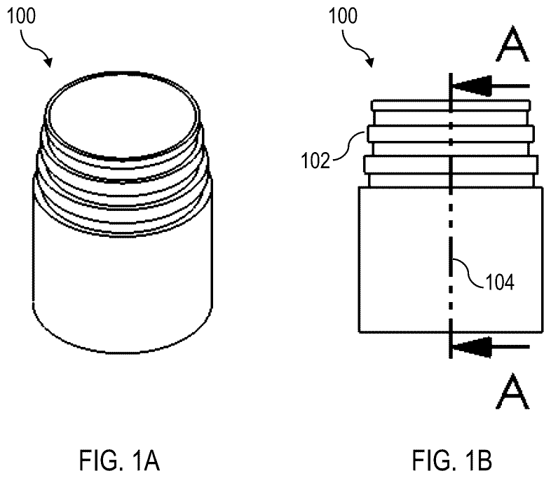

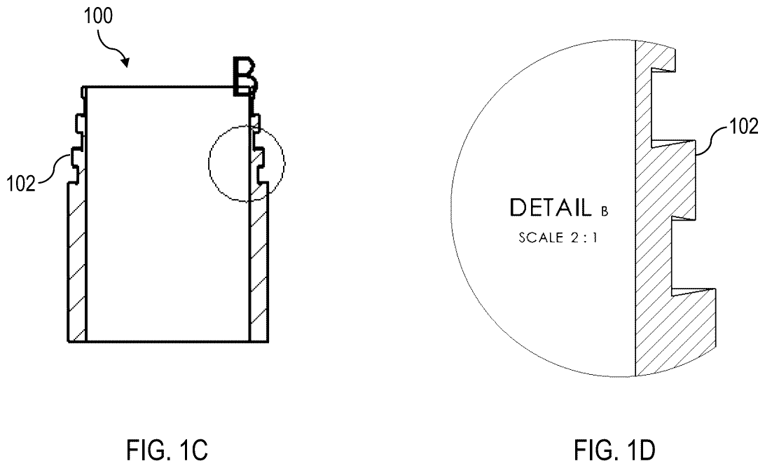

FIGS. 1A-1B depict an example pipe for measurement with the portable optical thread-profiling system. Referring to FIG. 1A, an example of a pipe 100 is shown. As shown in FIG. 1A, the example pipe is externally threaded at one end, with threads 102. Referring to FIG. 1B, dashed line 104 is shown running the length of pipe 100. Line 104 shows where the A-A cross-section shown in FIG. 1C is taken from. As used in this disclosure, “longitudinal axis” of the threaded portion of the pipe refers to the longitudinal direction indicated by line 104. When referring to an x-coordinate or an x-position, it refers to a position along the longitudinal axis.

FIGS. 1C-1D depict cross-sectional views of the example pipe for measurement with the portable optical thread-profiling system. Referring to FIG. 1C, cross-section of pipe 100 is shown. The cross-section is taken along the A-A dashed line shown in FIG. 1B. In the example pipe shown in FIGS. 1A-1D, pipe 100 includes a generic double negative load flank thread. A generic double negative load flank thread is a standardized heavy-duty thread profile used in OCTG and similar applications, where both mating threads have negatively angled load flanks to lock the connection under high stress, improve fatigue resistance, and reduce the risk of thread jump-out. FIG. 1D shows a zoomed-in view of the threads shown circled in FIG. 1C.

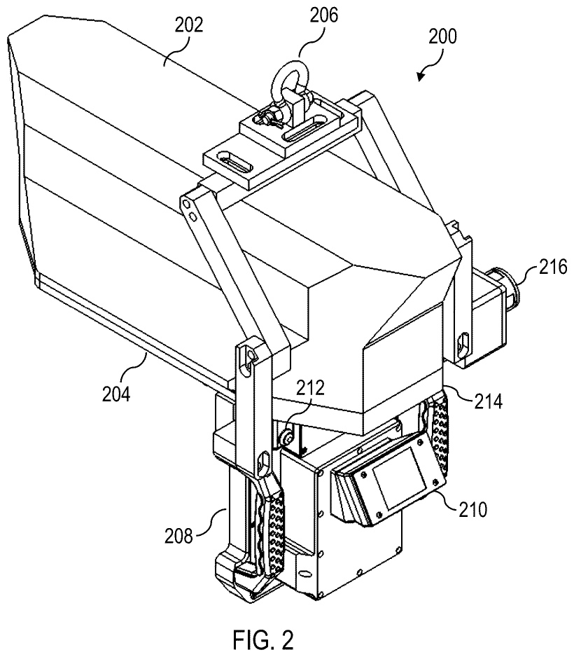

FIG. 2 shows a perspective view of the portable optical thread-profiling system. Referring to FIG. 2, portable optical thread-profiling system 200 is shown. Housing 202, face assembly 208, movement stage 204, hanging support assembly 206, LED display panel 210, cable plug 216, and release actuator 212 of system 200 are shown in FIG. 2. Measurement actuator 214 is not shown in FIG. 2 but is positioned on the right-hand side of LED display panel 210. Additional aspects of system 200 are described additional figures herein. Hanging support assembly 206 is configured to allow for connection to a zero-gravity arm, which may make the portable optical thread-profiling system “neutrally buoyant” such that users can easily use the system without having to lift the system, which, among other benefits, helps prevent damage to the pipe being measured because of easier handling of the system.

Portable optical thread-profiling system 200 is configured to evaluate thread profiles of pipes or other tubular members, such as pipe connectors or joints, used in various industrial applications. The system provides non-contact measurement capabilities for assessing thread geometry and dimensional characteristics of the pipe or other tubular member being measured. The system is designed to address limitations associated with conventional thread inspection methods that may involve time-consuming processes or subjective interpretations.

The system incorporates optical measurement technology to capture thread profile data with enhanced accuracy and repeatability. The system utilizes a clamping assembly to secure the pipe during measurement operations while maintaining proper alignment between the optical sensors and the threaded surfaces of the pipe. The system utilizes a movement system comprising a movement stage and a carriage thereon to provide controlled translation of the optical sensors along the longitudinal axis of the threaded portion of the pipe. The system further includes data processing capabilities that enable conversion of raw optical measurement data into meaningful thread profile representations.

The components of the system described herein are integrated into a compact package that enables portability. The portable design facilitates field deployment and on-site measurements in various operational environments where thread inspection may be required without requiring transportation of tubular members to dedicated inspection facilities. It supports rapid deployment for emergency inspections or quality control applications where immediate thread assessment is needed. It also supports rapid deployment across multiple inspection locations as operational needs dictate.

The system may be configured for handheld operation or mounting on a portable support structure. Power requirements may be optimized for battery operation or connection to available power sources in field environments.

The system may include protective features to ensure reliable operation in industrial settings with potential exposure to dust, moisture, or temperature variations. For example, housing 202 protects the components of the system 200 from environmental damage and physical damage.

FIG. 2 shows release actuator 212. In an embodiment, system 200 further includes a measurement actuator 214 (not shown in FIG. 2). Actuators 212 and 214 provide two functionalities. Measurement actuator 214 is used to begin a measurement operation. Release actuator 212 is used to release the clamping of the pipe. In an embodiment, release actuator 212 and measurement actuator 214 are each physical buttons.

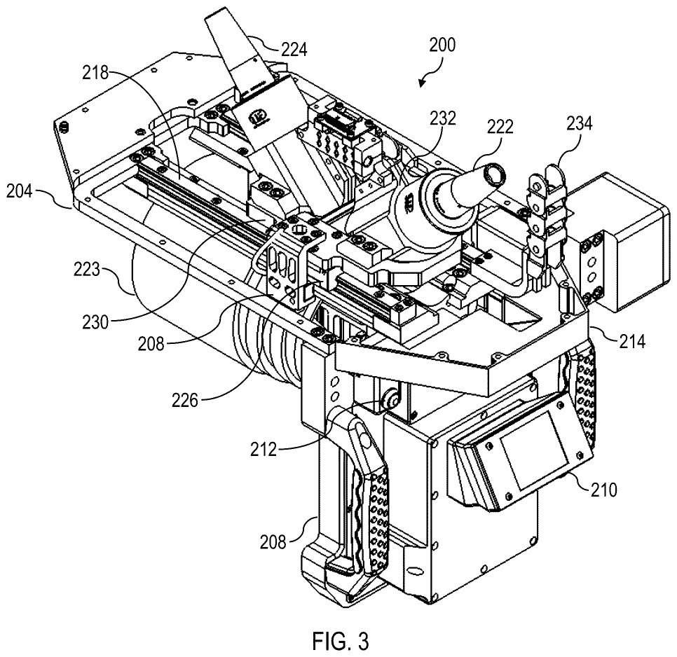

FIG. 3 shows a perspective view of the portable optical thread-profiling system with a pipe engaged. Referring to FIG. 3, portable optical thread-profiling system 200 is shown engaged with pipe 223. As can be seen in FIG. 3, when engaged with pipe 223, pipe 223 is positioned underneath movement stage 204, with the open end of pipe 201 positioned towards face assembly 208. Movement stage 204 includes two rails (first rail 218 and second rail 220) that run longitudinally. Two carriages (first carriage 226 and second carriage 228) are slidably coupled to rails 218 and 220, respectively, to allow for longitudinal movement along movement stage 204. Optical sensor mount 232 is coupled to both carriages (first carriage 226 and second carriage 228) to create a single moveable assembly. Optical sensors 222 and 224 are mounted on optical sensor mount 232, with an optional connector block positioned between the two optical sensors for stability and to provide rigidity. Movement stage 204 includes an aperture 236 (not shown in FIG. 3) that is configured to allow optical sensors 222 and 224 to see pipe 223 underneath movement stage 204 as carriages 226 and 228 and optical sensor mount 232 to move along rails 218 and 220. At least one carriage (for example, first carriage 226) includes a displacement sensor 238 coupled at one side of a rail. In an embodiment, displacement sensor 238 is an optical encoder read head.

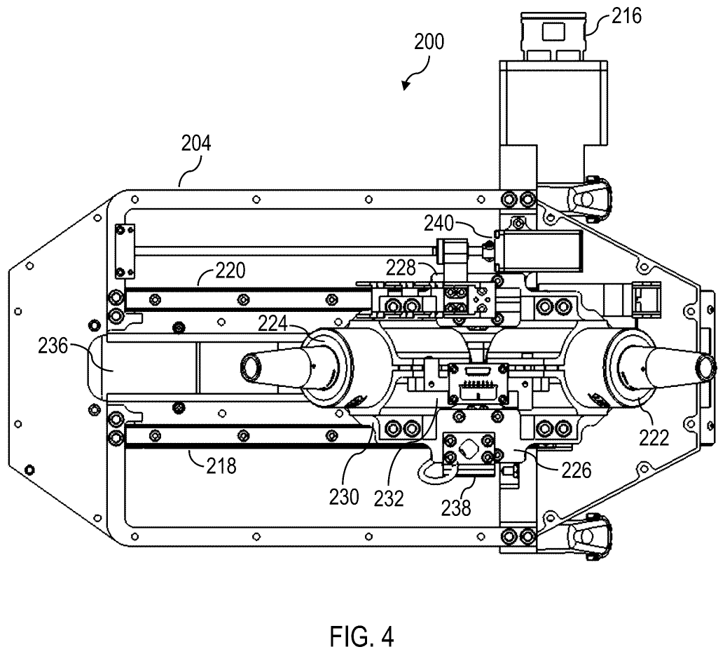

FIG. 4 shows a top view of the portable optical thread-profiling system. As can be seen from the top view of FIG. 4, first carriage 226 slides longitudinally (right-to-left and left-to-right as viewed from the perspective of FIG. 4) along first rail 218. Second carriage 228 slides longitudinally (right-to-left and left-to-right as viewed from the perspective of FIG. 4) along second rail 220. In an embodiment, rails 218 and 220 comprise linear recirculating ball rails to provide for smooth operation with minimal friction. Aperture 236 is shown in FIG. 4, which allows optical sensors 222 and 224 to see pipe 223 through movement stage 204.

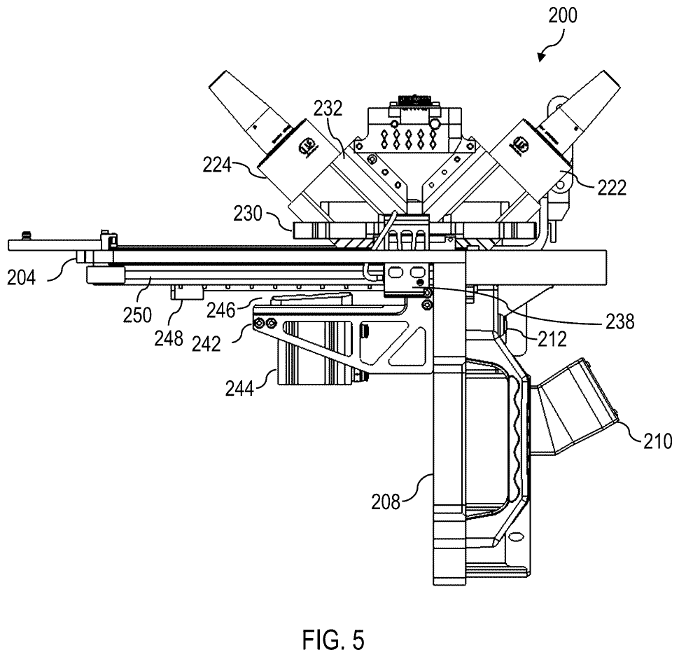

FIG. 5 shows a left-side view of the portable optical thread-profiling system. Referring to FIG. 5, movement stage 204 provides a flat portion that is positioned above a pipe to perform a measurement operation of the pipe's threads. Housing 202 engages movement stage 204 to protect the internal components of the system.

System 200 includes clamping assembly 242 disposed underneath movement stage 204. Clamping assembly 242 includes disposed therein a vertically translatable clamping actuator 244 having a clamping surface 252. Clamping surface 252 is configured to pivot to engage the pipe during clamping. An open end of a pipe is inserted into clamping aperture 246 such that clamping assembly 242 is positioned inside the pipe. Capacitive sensors 254 positioned on the face assembly 208 measure the distance to the face of the pipe as the pipe is inserted into clamping aperture 246. Clamping actuator 244 is electrically coupled to capacitive sensors 254 such that clamping actuator 244 is automatically actuated once the face of the pipe is sensed against face assembly 208. Clamping actuator 244 moves internal clamping surface 252 upwards towards the internal surface of the pipe such that internal clamping surface 252 engages the internal surface of the pipe to apply pressure against the internal surface of the pipe, thereby securing the outer surface of the pipe against the underside of movement stage 204. In one embodiment, clamping actuator 244 is an air-actuated solenoid.

System 200 includes displacement sensor 238 movably coupled to movement stage 204. Displacement sensor 238 is configured to move back and forth in the longitudinal direction of the threaded portion of the pipe so that measurements of the pipe can be taken.

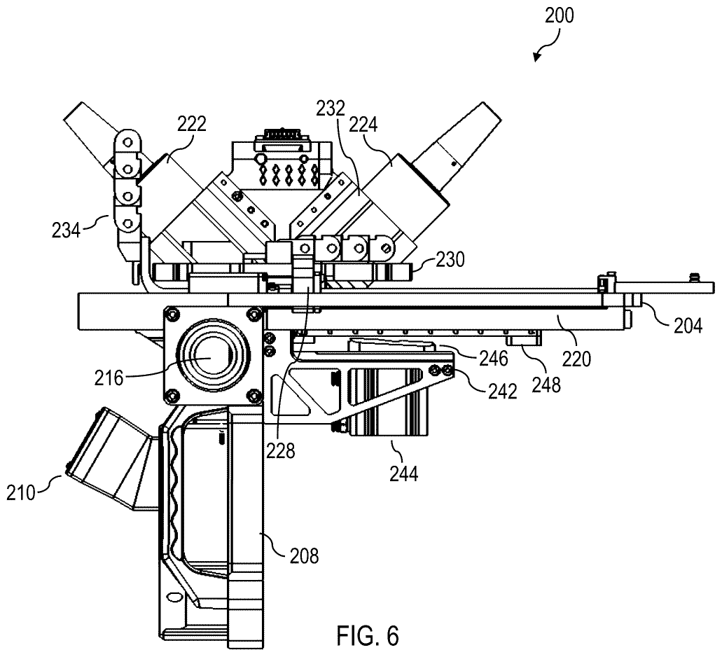

FIG. 6 shows a right-side view of the portable optical thread-profiling system. Referring to FIG. 6, system 200 further includes an energy chain 234 (not shown in the left-side view of FIG. 5) that holds and manages a cluster of wires for flexible application. In an embodiment, the cluster of wires held in energy chain 234 may include fiber optics wires for the optical sensors 222 and 224, encoder wires for the displacement sensor 238, and power cables.

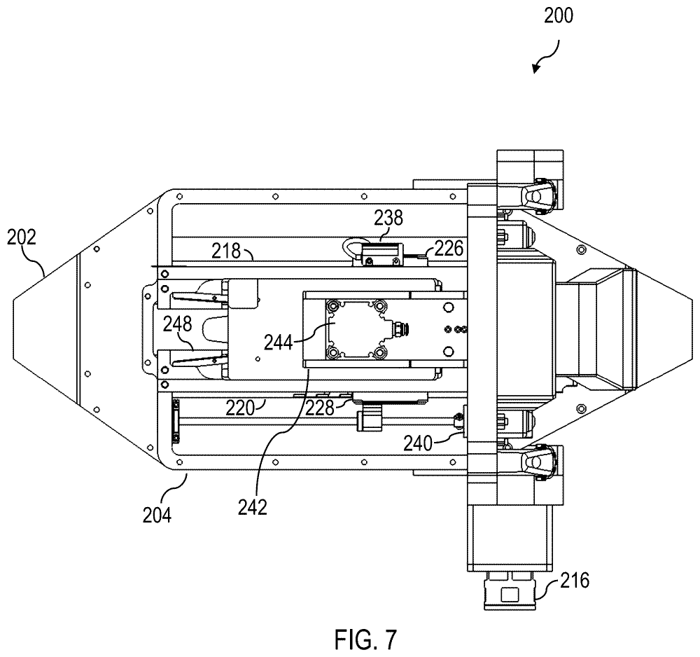

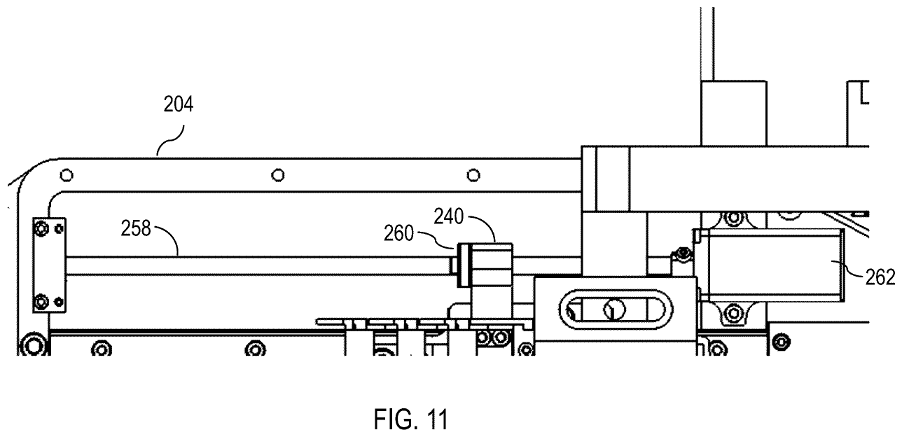

FIG. 7 shows a bottom view of the portable optical thread-profiling system. Referring to FIG. 7, first carriage 226 and second carriage 228 can be seen. First carriage 226 includes displacement sensor 238. Second carriage 228 is coupled to drive mechanism 240. Drive mechanism 240 causes second carriage 228, and therefore the entire observation platform 230, to move back and forth along the longitudinal axis. Drive mechanism 240 is shown and described in more detail in FIG. 11. Cable plug 216 provides an input point for connecting one or more cables to the system. The cables include power cables, signal cables, and the air supply line for clamping actuator 244. In an embodiment, cable plug 216 provides a standardized connection interface to allow the system to be connected to one or more computer systems.

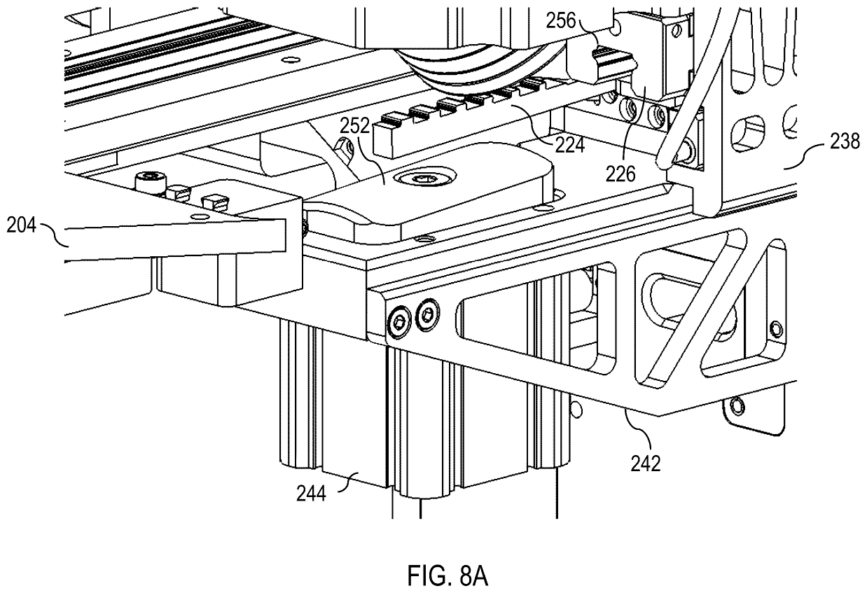

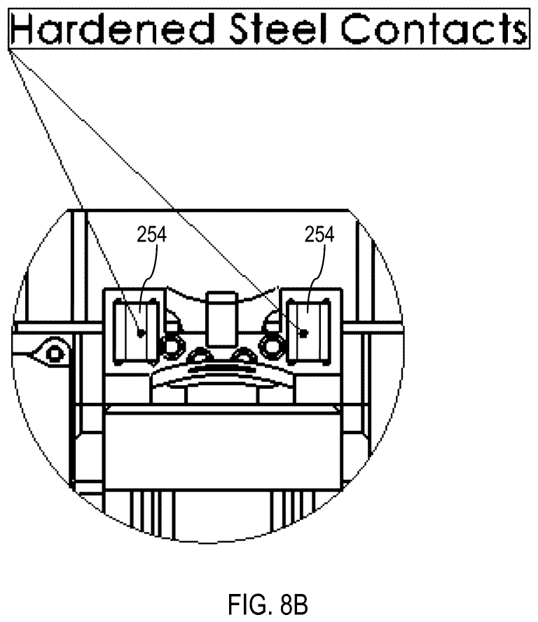

FIG. 8A shows a view of the clamping assembly of the portable optical thread-profiling system. Selected portions of system 200 are intentionally not shown in FIG. 8A to allow for a better view of the interior of system 200. Similarly, a portion of pipe 201 is shown to provide context for where the threads are located; however, the rest of pipe 201 is not shown. First rail 218 is likewise not shown in FIG. 8A to allow for a better view of the inner portions. Referring to FIG. 8A, the clamping assembly 242 includes clamping actuator 244 having internal clamping surface 252. Clamping assembly 242 may accommodate various pipe diameters and wall thicknesses commonly encountered in industrial applications. Movement of clamping actuator 244 is controlled by an air-actuated solenoid that is communicatively coupled to one or more capacitive sensors 254 that detect contact with the face of the pipe and send an activation signal. When activated, clamping actuator 244 moves upward to create a clamping force against the internal surface of the pipe. The clamping force provided by clamping actuator 244 may be controlled to provide adequate attachment to the pipe without causing deformation of the pipe being measured. In some embodiments, clamping assembly 242 may incorporate both internal and external clamping portions that work in coordination to attach to the pipe. Clamping assembly 242 may be adjustable to accommodate different pipe geometries and threading configurations. The attachment between the system and the pipe provided by clamping assembly 242 prevents relative motion between the pipe and the system 200 that could introduce measurement errors. Clamping assembly 242 may be designed for rapid engagement and release of the pipe to minimize setup time between measurements. The system 200 may include features to verify proper clamping engagement before initiating measurement sequences.

FIG. 8B shows a view of capacitive sensors that detect contact with the face of the pipe. As described in the context of FIG. 8A, the system includes one or more capacitive sensors 254. Referring to FIG. 8B, the capacitive sensors 254 comprise two hardened steel contacts that interface with the pipe face. The capacitive sensors 254 apply high-frequency pulse-width modulation and a reading of when the pipe has contacted the sensors via analog input.

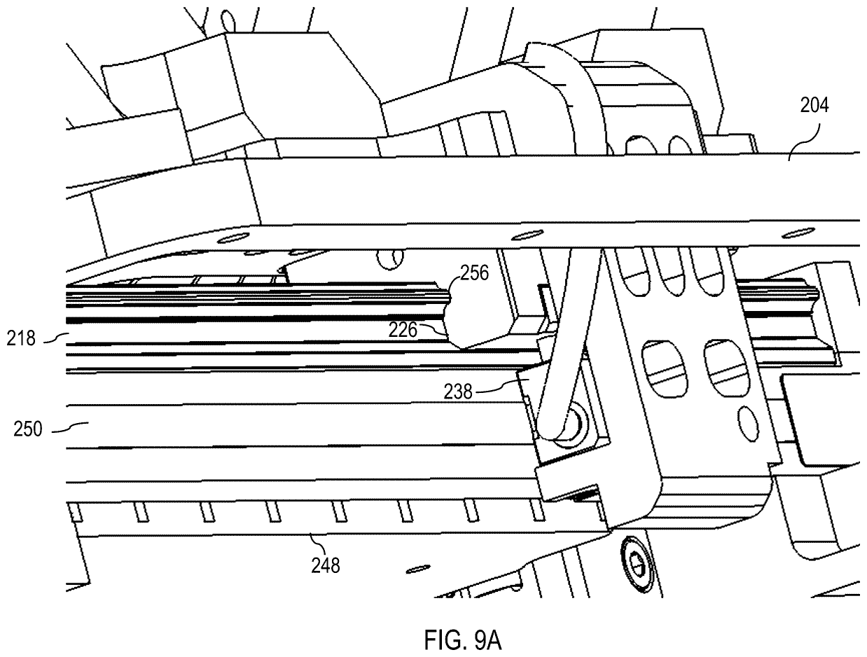

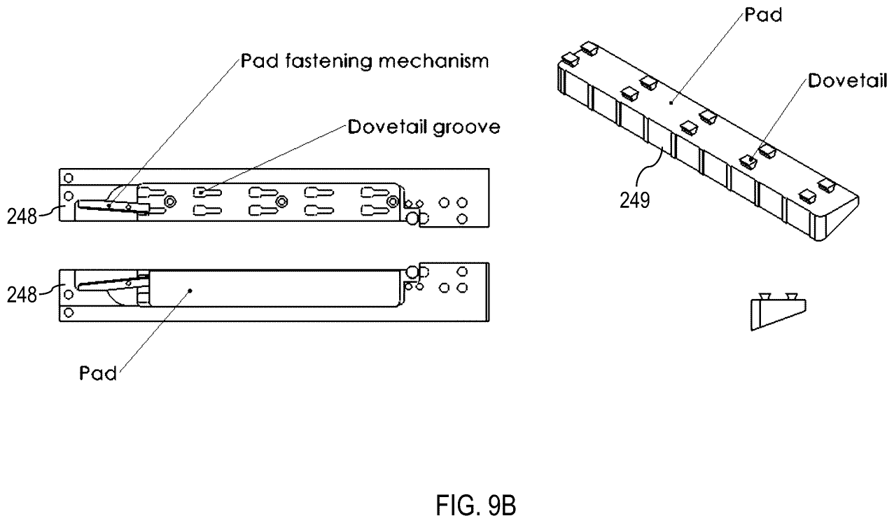

FIG. 9A shows a view of a displacement sensor on one carriage of the observation platform. Referring to FIG. 9A, in an embodiment, the displacement sensor 238 comprises an optical encoder read head and a corresponding encoder strip 250. The optical encoder read head reads a displacement value from encoder strip 250. As can be seen in FIG. 9A, the optical encoder read head is mounted on first carriage 226, which includes channel portion 256 that slidably engages first rail 218 of movement stage 204. Second carriage 228 is on the opposite side of movement stage 204, and the two carriages are connected to one another by the optical sensor mount 232 that holds the two optical sensors (e.g., spectrometer probes) 222 and 224. Together the two carriages, including the displacement sensor on one side, plus the two optical sensors mounted on the mount that connects the two carriages, forms observation platform 230. Rails 218 and 220 run in the same direction as the longitudinal axis of the threaded portion of the pipe. Displacement sensor 238 provides precise position tracking capabilities for the observation platform during thread measurement operations through the implementation of optical linear position sensing. In some embodiments, displacement sensor 238 is an optical encoder read head that utilizes optical sensing to read position data from encoder strip 250 to generate electrical signals that correspond directly to the mechanical position of observation platform 230 (via first carriage 226) along first rail 218, which is along the longitudinal measurement axis. Accuracy of displacement sensor 238 may be determined by the resolution characteristics of the sensing element and the mechanical precision of the coupling between the sensor and the rest of the observation platform. The displacement sensor may operate continuously during measurement operations to provide real-time position feedback for correlation with the surface profile data generated by the optical sensors. The output signals of the displacement sensor may be processed through analog-to-digital conversion systems that preserve the position data with sufficient resolution to support micron-level measurement accuracy in the x-direction (i.e., along the longitudinal axis of the threaded portion). Acquisition of position data of the observation platform using the displacement sensor 238 may be synchronized with the acquisition of optical sensor data to ensure temporal correlation of surface profile information with spatial location data.

Pad holder 248 provides a mechanism for attaching a spacer pad to the system. The spacer pad is used to create proper spacing of the pipe for optical measurement. The optical sensors have narrow vertical windows in which they can effectively perform optical measurements. In an embodiment, the optical sensors have an effective measurement range of 3.7 mm along the optical axis. Because the optical sensors are angled, the true effective measurement range in the vertical direction (relative to the pipe) is approximately 2.6 mm, calculated as 3.7 mm (i.e., full optical range) multiplied by sin(45°) (i.e., the approximate angle of the optical sensors), which is approximately equal to 2.6 mm. Therefore, the full range of the threads being measured needs to fall within the 2.6 mm effective measurement window. In another embodiment, the optical sensors have an effective measurement range of 4.3 mm along the optical axis. Because the optical sensors are angled, the true effective measurement range in the vertical direction (relative to the pipe) is approximately 3.0 mm. Therefore, the full range of the threads being measured should be positioned to fall within the 3.0 mm effective measurement window. Because the optical sensors have a narrow effective measurement window in the vertical direction, the pipe should be mounted vertically within 4/1000 of an inch (relative to the top of the threads) from the optical sensors. If the pipe is mounted too low relative to the optical sensors, the optical sensors will not be able to read the valleys of the threads. If the pipe is mounted too high relative to the optical sensors, the optical sensors will not be able to read the peaks of the threads. Spacer pads 249 are used to create correct spacing. The spacer pads 249 are removably attached to pad holder 248.

FIG. 9B shows a view of the pad holder and a pad. Referring to FIG. 9B, pad holder 248 comprises a plurality of dovetail grooves and a pad fastening mechanism. A pad 249 includes a plurality of dovetails configured to engage the dovetail grooves of the pad holder 248. The pad fastening mechanism is configured to tighten a loaded pad 249 into place.

In some embodiments, the displacement sensor 238 may be calibrated using a calibration procedure to establish a relationship between electrical output signals and actual mechanical displacement distances. In some cases, the calibration procedure may involve positioning the observation platform at known locations along the measurement range while recording the corresponding outputs from the displacement sensor. The calibration standards may include precision gauge blocks or optical measurement systems that provide traceable dimensional references for the position calibration procedures. The calibration data may be processed through curve-fitting algorithms that determine the mathematical relationships between potentiometer voltages and mechanical positions while accounting for any nonlinearity characteristics. The calibration coefficients may be stored in non-transitory computer readable storage media for application to subsequent position measurements during thread profiling operations. The calibration frequency may be established based on the stability characteristics of the potentiometer and the accuracy requirements of the thread measurement application. The calibration documentation may include records of the calibration procedures and results to provide traceability for quality assurance purposes.

In an embodiment, the implementation of position sensing utilizes optical sensing to generate x-location outputs proportional to the mechanical position of the optical encoder read head relative to encoder strip 250. Encoder strip 250 includes optically readable markings that are read by the optical encoder read head. Encoder strip 250 operates similar to a bar code that is read by the optical encoder read head. In an embodiment, encoder strip 250 is an optical linear encoder strip from Renishaw Electronics. The linear encoder strip may be an absolute linear encoder or an incremental linear encoder. Encoder strip 250 is fabricated from materials that provide stable electrical characteristics over extended operational periods in harsh operating environments while maintaining low-or no-friction contact with the optical encoder read head ). The optical encoder read head and/or the encoder strip may include a housing sealed against environmental contamination to prevent degradation of the elements or contact surfaces during field operations. The electrical connections to the optical encoder read head may incorporate shielded cables to minimize electromagnetic interference that could affect position measurement accuracy. The linearity characteristics of the optical encoder read head and encoder strip 250 may be specified to ensure that the output data maintains proportional relationships with mechanical displacement of the observation platform throughout the measurement range.

The electrical characteristics may be selected to provide optimal signal-to-noise ratios and measurement resolution for optical position sensing while maintaining compatibility with the data acquisition electronics. In some cases, the granularity of the encoder strip 250 may be chosen to provide adequate output differentiation while minimizing power consumption and thermal effects that could affect measurement stability. The temperature coefficient characteristics of the optical sensing may be selected to minimize thermal drift effects that could introduce position measurement errors over the operating temperature range. The electrical noise characteristics may be minimized through selection of optical sensing designs with low-or no-contact variations and stable materials.

The optical encoder read head, working in concert with encoder strip 250, generates x-location data that is used to establish the longitudinal position of the observation platform, and, therefore, the spectrometric measurements relative to the threaded pipe geometry. In some cases, the x-coordinate system may be aligned with the longitudinal axis of the threaded pipe to provide spatial reference information for the surface profile measurements captured by the optical sensors. The x-location data may be expressed in engineering units such as millimeters or inches to provide dimensional information compatible with thread specification requirements. The coordinate origin may be established through calibration procedures that reference the x-location data to known geometric features of the measurement system or the threaded pipe. The resolution of the x-location data may be determined by the electrical resolution of the optical encoder read head and the mechanical coupling ratio between the observation platform displacement and the optical encoder read head input motion. The x-location data may be processed through computational algorithms that apply calibration factors to convert raw optical sensor outputs (based on the encoder strip) into calibrated position measurements for the spectrometers. The x-location data is combined with coordinate data generated by the spectrometers to generate a two-dimensional (2D) representation of the thread profile.

The optical encoder read head is configured to provide sufficient resolution and sampling rates to capture x-location data with accuracy compatible with the optical sensor (e.g., spectrometers) measurement requirements. In some cases, the analog-to-digital converter resolution may be selected to provide x-location data increments that are smaller than the required spatial accuracy of the thread profile measurements.

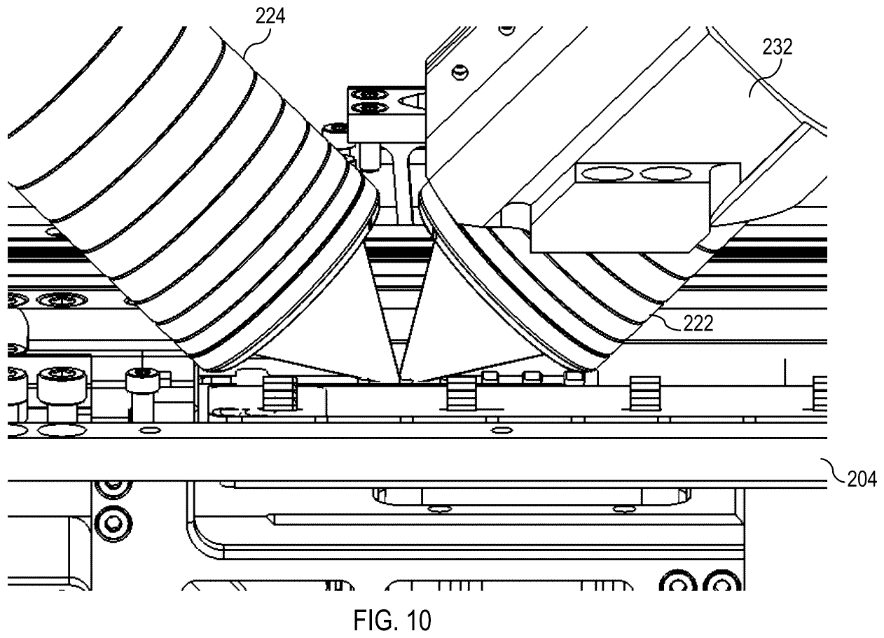

FIG. 10 shows a view of the optical sensors of the portable optical thread-profiling system. System 200 utilizes optical measurement to capture surface profile information of threaded connections. The optical measurement approach eliminates physical contact with the threaded surfaces of the pipe, thereby avoiding potential damage or wear that might occur with mechanical gauging methods. Optical sensors operate at high sampling frequencies to capture detailed surface information as the optical sensors traverse the threaded region of the pipe. The resulting data is converted into coordinate information that represents the two-dimensional (2D) thread profile.

Referring to FIG. 10, system 200 includes a first optical sensor 222 and a second optical sensor 224. In some embodiments, the first optical sensor 222 and the second optical sensor 224 are spectrometric measuring devices, such as confocal spectrometers. A confocal sensor detects light focused at a single point to achieve very accurate, high-resolution measurements. Confocal sensors project white or monochromatic light through a multi-lens optical system that focuses different wavelengths (or focal points) at different distances along the optical axis. When the target surface lies at one of these focal points, only the light from that specific distance is reflected back through the same optical path and passes through a pinhole aperture in front of the detector. Because light reflected from other depths is out of focus and blocked by the pinhole, the system can isolate the precise distance along the optical path of the surface with micron or sub-micron precision. In an embodiment, the optical sensors are MicroEpsilon confocalDT IFS2407 spectrometers. The MicroEpsilon confocalDT IFS2407 includes a large probe, which allows for the angular positioning of the optical sensors while still maintaining an effective operating window that is sufficient in size to allow for accurate thread profile measurements.

Spectrometers provide for better resolution than other measurement technologies, such as, for example, interferometers. Additionally, spectrometers provide an absolute measurement, which can make the calculations used to determine the thread profile easier to perform.

The first optical sensor 222 (e.g., spectrometer probe) is positioned at a forward angle relative to the outer surface of the threaded pipe to capture surface profile information from a specific geometric perspective. In some cases, the angular positioning may be selected to optimize the measurement sensitivity for thread flank angles and root geometries commonly encountered in pipe threading applications. The forward angle orientation may provide enhanced visibility of thread features that face toward the direction of measurement travel. The optical axis of the first optical sensor may be inclined at angles ranging from approximately fifteen degrees to forty-five degrees relative to the pipe surface normal. The specific angular configuration may be determined based on the thread pitch and profile geometry of the target threading specifications. The forward-angled positioning may enable measurement of thread surfaces that might be shadowed or obscured when viewed from perpendicular orientations. Optical components within the first optical sensor may include beam splitters, reference mirrors, and focusing elements arranged to generate stable interference patterns. The measurement beam path may be designed to maintain consistent optical path lengths throughout the scanning range.

The second optical sensor 224 (e.g., spectrometer probe) is positioned at a rearward angle relative to the outer surface of the threaded pipe to provide complementary measurement data from an opposing geometric perspective. The rearward angular orientation captures thread profile information from surfaces that face away from the direction of measurement travel. The dual-angle measurement approach enables comprehensive characterization of the thread profile including both flanks of individual thread features. The rearward angle of second optical sensor 224 may be configured as a mirror image of the forward angle of first optical sensor 222 to provide symmetric measurement coverage of the threaded region. The angular separation between the first and second optical sensors may range from approximately 30 degrees to approximately 90 degrees depending on the thread geometry and measurement requirements. The rearward-facing second optical sensor 224 may utilize similar or identical optical components as the forward-facing first optical sensor 222 to ensure measurement consistency.

Because the optical sensors 222 and 224 are each positioned at an angle, the system performs additional mathematical calculations to determine the coordinates of the surface. As explained above, confocal sensors read distance along the optical axis. In this case, because the optical sensors are positioned at an angle, the optical axis is likewise at an angle, which means that the x and y coordinates are then determined based on the readings from the optical axis. In an embodiment, each optical sensor (222, 224) generates a single numerical output of a value between 0 and 3.7, which represents the distance in millimeters along the optical axis (i.e., the hypotenuse) from the optical sensor to the surface of the pipe. From that numerical output that represents a distance along the optical axis, the system determines the x and y coordinates.

The combined data from both optical sensors provides enhanced measurement accuracy compared to single-sensor configurations.

Optical alignment between the two optical sensors is maintained through a mount that preserves the relative angular relationships during measurement operations. A portion of optical sensor mount 232 is shown in FIG. 10. For convenience and clarity of illustration, the entire optical sensor mount 232 is not shown in FIG. 10; however, optical sensor mount 232 is used to secure both optical sensors. The mount provides a stable mechanical platform for maintaining precise optical alignment during measurement operations. In some cases, the mount may incorporate kinematic mounting principles to ensure repeatable positioning of the optical sensors. The mechanical stability may be enhanced through the use of rigid materials and vibration-dampening elements that minimize disturbances to the optical paths of the optical sensors. The mount may include adjustment mechanisms for fine-tuning the angular positions of the optical sensors relative to the measurement surface. The mechanical design may accommodate thermal expansion effects that could alter the optical alignment over temperature ranges encountered in field applications. The mount may be designed for rapid installation and removal to facilitate system maintenance or replacement of the optical sensors. The structural elements may be fabricated from materials with low thermal expansion coefficients to maintain dimensional stability. The mount may incorporate precision bearing systems to enable smooth angular adjustments when required.

In some embodiments, optical sensors 222 and 224 use spectrometric measurement principles to capture raw optical measurement data during measurement operations. The raw optical measurement data is processed through computational algorithms to extract relevant thread profile characteristics and dimensional parameters.

The optical sensors utilize a light source, such as a white (broadband) LED, a multi-wavelength light, a laser, or a coherent light source to generate a reflection pattern that corresponds to surface height variations along the threaded regions. The measurement resolution may be determined by the wavelength of the light source(s), the sensitivity of the detection system, and/or the frequency (e.g., 2 kHz). The optical sensors may incorporate light sources operating at specific wavelengths optimized for surface measurement applications. Signal processing electronics convert the optical data into raw optical measurement data suitable for computational analysis.

The optical beam characteristics of the optical sensors may be optimized for thread measurement applications through selection of appropriate wavelengths and beam geometries. In some cases, the light sources may operate at wavelengths in the visible or near-infrared spectrum to provide optimal reflection characteristics from metallic thread surfaces. The beam diameter may be sized to provide adequate spatial resolution while maintaining sufficient optical power for reliable detection. The beam divergence may be controlled through focusing optics to maintain consistent spot sizes throughout the measurement range. The optical power levels may be selected to ensure adequate signal-to-noise ratios while remaining within safe exposure limits for operational personnel. The beam polarization may be controlled to optimize reflection characteristics from the threaded surfaces being measured. The optical coherence length may be sufficient to accommodate the range of surface height variations encountered in typical thread geometries.

The optical sensor detection systems may incorporate a spectral detector, photodetector arrays, or single-element detectors configured to capture interference fringe patterns with high sensitivity. In an embodiment, the optical sensors are confocal spectrometer probes that transmit signals via fiber optic cable to a spectrometer controller, which decodes the signals as part of spectral detection. In some cases, the photodetector elements may be selected for optimal response characteristics at the operating wavelengths of the optical sensor's light sources. The detection bandwidth and detector response time may be sufficient to accommodate the high-frequency sampling requirements of the measurement system. The detector noise characteristics may be minimized through the use of low-noise amplification circuits and appropriate detector cooling systems. The dynamic range of the detection systems may be optimized to handle the range of signal levels encountered during thread measurement operations. The detector linearity may be maintained over the full range of optical power variations to ensure measurement accuracy. The detection electronics may incorporate analog-to-digital conversion systems with sufficient resolution to preserve the spectrometric phase information.

The optical sensors sample at high frequencies to capture detailed surface information during the scanning process. For example, in some embodiments, each optical sensor samples surface height data at a frequency of 2 kHz to determine displacement. In some embodiments, each optical sensor may sample surface height data at frequencies of 25 kHz or higher to ensure adequate spatial resolution along the measurement path. The high sampling rates enable detection of fine surface features and irregularities that might be missed with lower frequency measurement systems. The data acquisition timing may be synchronized between the two optical sensors to ensure temporal correlation of the measurement data. The sampling frequency may be adjustable to accommodate different scanning speeds and measurement resolution requirements. The high-frequency operation may require specialized signal processing electronics capable of handling the resulting data rates. The optical sensors and/or their optical sensor controller may incorporate buffer memory systems to temporarily store raw optical measurement data during high-speed scanning operations. The data transfer rates between the optical sensors and the optical sensor controller may be optimized to prevent data loss or measurement interruptions.

The optical sensors and/or their optical sensor controller may incorporate compensation mechanisms to account for environmental factors such as temperature variations or vibrations that could affect measurement accuracy. The optical components may be mounted in thermally stable housings to minimize thermal drift effects. The beam alignment systems may include adjustment mechanisms to maintain optimal optical performance throughout the measurement range.

The coordinate data generation capabilities of the optical sensors and/or their optical sensor controller convert raw optical measurement data into displacement values along the optical axis, which is then converted to (x, y) coordinate data representing the thread profile. In some cases, the spectrometric phase measurements may be processed through algorithms that calculate surface height values. The conversion process may involve trigonometric calculations that account for the angular positioning of each optical sensor relative to the measurement surface, as described above. In particular, the raw optical measurement data from the optical sensors represents distance along the optical axis, which is converted using trigonometry to determine (x, y) coordinate data. The resulting coordinate data may be expressed in Cartesian coordinate systems with x-coordinates representing longitudinal position and y-coordinates representing radial height variations. The coordinate accuracy may be influenced by the optical wavelength, detection sensitivity, and angular calibration precision of the spectrometer systems. The data processing algorithms may incorporate error correction routines to compensate for systematic measurement errors or optical aberrations. The coordinate data may be generated in real-time during measurement operations or through post-processing of stored spectrometric data. The spatial resolution of the coordinate data may be determined by the combination of sampling frequency and scanning velocity.

In some embodiments, the optical sensors and/or their optical sensor controller may include environmental compensation capabilities that account for external factors that could influence measurement accuracy during field operations. In some cases, compensation algorithms correct for atmospheric pressure variations that affect the optical path lengths through air between the optical sensors and the measurement surface. Temperature compensation may account for thermal effects on the optical components, mechanical structures, and the dimensional characteristics of the threaded pipes being measured. Vibration isolation systems may be utilized to minimize effects of external mechanical disturbances on the spectrometric measurements. Environmental monitoring sensors may provide real-time data on temperature, humidity, and pressure conditions for use in the compensation calculations. The compensation algorithms are implemented through software routines that apply correction factors to the raw optical measurement data. The environmental effects may be characterized through laboratory testing and field validation studies to develop appropriate compensation models.

FIG. 11 shows a view of the displacement sensor on the carriage of the observation platform. As discussed above, the system utilizes a movement system comprising a stationary movement stage 204 and a moveable observation platform 230 slidably mounted (via carriages 226 and 228) thereon. The optical sensors are mounted on the observation platform 230. The observation platform 230 provides controlled translation of the optical sensors 222, 224 along the longitudinal axis of the threaded portion of the pipe. Referring to FIG. 11, the movement system incorporates a precision drive mechanism 240 to ensure smooth and accurate positioning of the optical sensors 222, 224. In an embodiment, drive mechanism 240 comprises a ball screw 258 and a corresponding ball nut 260, with the ball screw 258 being rotationally driven by electric motor 262. In one embodiment, ball screw 258 has a 1 mm pitch, such that each revolution of ball screw 258 moves carriage 215 by 1 mm of linear travel. Other types of drive mechanisms may be used as well, such as a lead screw, an electric linear actuator, a belt drive, a rack and pinion system, a linear motor, a cam and follower, or a crank/rotary system. The translation speed of the observation platform may be controlled to optimize data acquisition while maintaining measurement accuracy. The movement range of the observation platform may be adjustable to accommodate different thread lengths and configurations. The drive mechanism 240 is capable of bidirectional movement to enable multiple measurement passes or verification scans. The movement stage 204 may incorporate vibration dampening features to minimize disturbances that could affect measurement precision. The positioning accuracy of the observation platform may directly influence the spatial resolution of the resulting thread profile measurements.

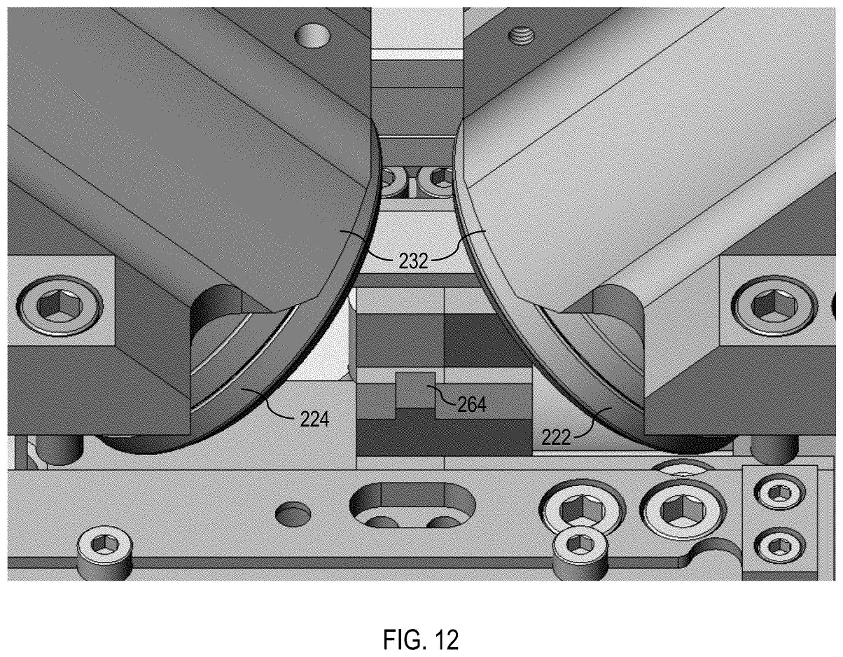

FIG. 12 shows a view of the calibration feature of the movement stage. Referring to FIG. 12, calibration feature 264 is positioned on movement stage 204 along the optical measurement path. Calibration feature 264 is positioned toward the face assembly 208 on movement stage 204. This positioning allows the optical sensors to read calibration feature 264 during each measurement pass before reaching the beginning of the threaded region of the pipe.

Calibration feature 264 may be implemented as a fixed reference structure integrated into movement stage 204 to provide a known geometric standard for optical sensor alignment calibration and verification. In an embodiment, calibration feature 264 is a machined block with known dimensions of 2 mm (tall) by 5 mm (wide). Having known dimensions for calibration feature 264 allows the system to computationally “stitch” the readings from the optical sensors together in space. In some cases, calibration feature 264 may comprise a precision-machined thread pattern with certified dimensional characteristics that serve as a series of reference point for spectrometer angle determination. The fixed positioning of calibration feature 264 on movement stage 204 ensures consistent availability for calibration procedures without requiring external reference standards or setup procedures. Calibration feature 264 may be fabricated or machined from dimensionally stable materials such as hardened steel or ceramic composites that maintain geometric accuracy over extended operational periods. The thread pattern of calibration feature 264 may conform to standardized thread specifications with precisely controlled pitch, flank angles, and root geometries. The surface finish of calibration feature 264 may be optimized to provide consistent optical reflection characteristics for spectrometric measurements. The dimensional tolerances of calibration feature 264 may be maintained within micron-level accuracy to support high-precision calibration procedures. Calibration feature 264 may be positioned to align with both the first and second spectrometer measurement paths during calibration sequences. The known thread reference characteristics of calibration feature 264 enable systematic determination of spectrometer angular positioning through comparison of measured thread geometry with known reference dimensions.

In some embodiments, calibration feature 264 may be removably mounted on movement stage 204. The mount provides stable mechanical support while maintaining precise geometric relationships with the spectrometer measurement paths. In some cases, the mount may incorporate kinematic mounting principles to ensure repeatable positioning of calibration feature 264 relative to the optical measurement components. The mount may be fabricated from materials with low thermal expansion coefficients to minimize dimensional changes that could affect calibration accuracy. The mount may include adjustment mechanisms for initial alignment of the calibration feature with the spectrometer measurement beams. The mechanical stability of the mount may be enhanced through the use of rigid structural elements and vibration-dampening materials. The mount may be designed to prevent contamination or damage to the calibration feature surfaces during normal operation.

The system may incorporate per-measurement calibration procedures of the spectrometers using calibration feature 264 to ensure measurement accuracy and compensate for environmental factors or system variations. The calibration procedures may ensure measurement accuracy through the use of reference standards and systematic error correction techniques. In some cases, the calibration procedure involves measurement of known surface features or step heights of the calibration feature to establish the relationship between spectrometric phase measurements and actual surface displacements. The calibration procedures may be used to generate coefficients that may be applied to the raw optical measurement data through computational algorithms that convert phase measurements to dimensional values.

The calibration feature may include precision machined surfaces or optical flats with certified dimensional characteristics. The calibration frequency may be established based on the stability requirements of the measurement application and the environmental conditions encountered during operation. The calibration data may be stored in non-transitory computer readable storage media for use in subsequent measurement calculations. The calibration procedures may account for systematic errors such as optical aberrations, detector nonlinearities, or mechanical alignment variations.

In some cases, the calibration procedure may involve scanning the calibration feature with both spectrometers to capture surface profile data from the known thread pattern. The measured profile data may be compared with the theoretical thread geometry to calculate angular deviations or alignment errors in the spectrometer positioning. The calibration algorithms may utilize trigonometric relationships between the measured thread flank angles and the known reference angles to determine the actual angular orientation of each spectrometer. The angular determination process may account for both pitch angle variations and radial positioning errors that could affect measurement accuracy. The calibration feature may incorporate multiple thread pitches or thread forms to provide comprehensive angular calibration data across different geometric configurations. The reference thread dimensions may be traceable to national measurement standards to ensure calibration accuracy and measurement traceability. The calibration feature may include identification markings or documentation that specify the certified dimensional characteristics and measurement uncertainties.

Automated calibration procedures may be executed before each measurement pass to account for thermal effects or mechanical variations. In some cases, the calibration procedure may involve rapid scanning of the calibration feature as part of the measurement pass to capture current angular alignment data without significant delay to the measurement pass. The real-time calibration may compensate for thermal expansion effects that could alter the mechanical positioning of the spectrometers relative to the measurement surface. The calibration frequency may be adjustable to accommodate different operational requirements or environmental stability conditions. The real-time angular alignment data may be stored in system memory for use in coordinate transformation calculations during thread profile measurements.

The geometry of calibration feature 264 may incorporate specific thread forms that optimize the angular determination accuracy for the dual spectrometer measurement configuration. In some cases, the calibration feature pattern may include symmetric V-thread profiles with precisely controlled flank angles that provide clear angular reference surfaces for both spectrometers. The thread pitch of the calibration feature may be selected to provide adequate spatial resolution for angular measurements while accommodating the optical spot sizes of the spectrometer beams. The thread depth of the calibration feature may be sufficient to generate measurable height variations that enable accurate surface profile reconstruction during calibration scans.

The calibration data processing algorithms may convert the measured thread profile information from the calibration feature into angular correction factors for application to subsequent measurements. In some cases, the processing routines may compare the measured thread flank angles with the known reference angles to calculate angular deviations for each spectrometer. The calibration algorithms may utilize least-squares fitting techniques to determine the best-fit angular orientations that minimize measurement errors across the calibration thread pattern. The angular correction factors may be applied to the coordinate transformation calculations that convert spectrometric measurements into spatial coordinates. The calibration data processing may account for systematic errors such as optical aberrations or detector nonlinearities that could affect angular determination accuracy. The processing algorithms may include error detection routines that identify calibration anomalies or measurement inconsistencies that could indicate system malfunctions. The calibration results may be validated through comparison with previous calibration data to detect drift or degradation in system performance. The processed calibration data may be formatted for storage in system memory and retrieval during subsequent measurement operations.

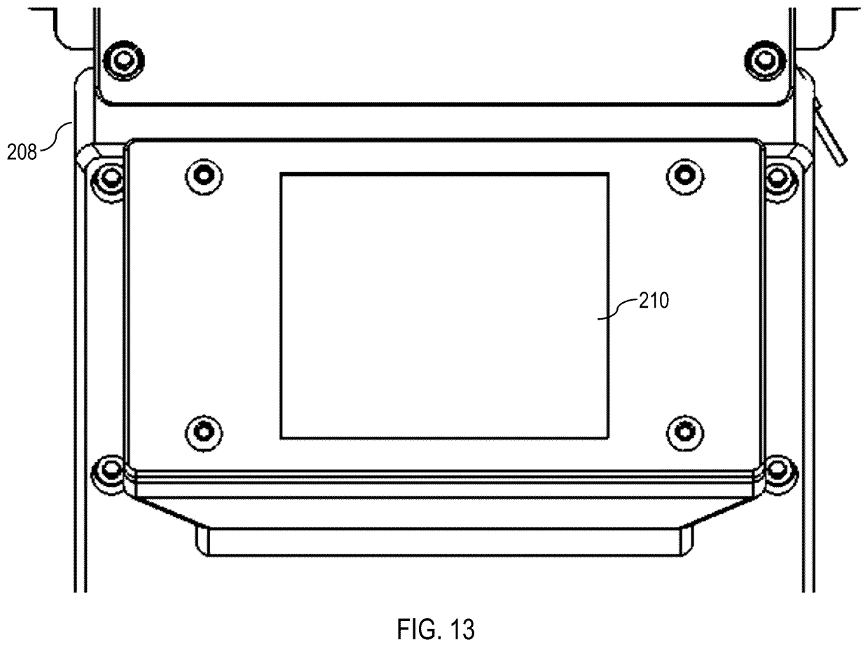

FIG. 13 shows a view of the LED panel display system. Referring to FIG. 13, LED display panel 210 may provide visual feedback and status information to operators during thread measurement operations through the implementation of light-emitting diode arrays configured for high-visibility operation in various lighting conditions. LED display panel 210 provides visual feedback to the user, including, for example, providing an indication to the user when the system has been successfully clamped on the pipe, providing any alarms or errors, showing results from measurements, and/or displaying thread profile values. In some cases, the LED panel may incorporate multiple discrete light-emitting elements arranged in matrix configurations that enable display of alphanumeric characters, symbols, and graphical indicators. The LED panel may utilize surface-mount technology components with wavelengths selected for optimal visibility under both indoor and outdoor lighting conditions encountered in field measurement applications. The LED panel may incorporate multiple color capabilities through the use of red, green, and blue light-emitting elements that enable color-coded status indications for different operational modes or measurement conditions. The panel housing may provide environmental protection against dust and moisture ingress while maintaining optical clarity for the light-emitting elements. The LED panel may be positioned on the face assembly 208 to provide direct visual access for operators during measurement setup and operation procedures. The display update rates may exceed ten hertz to provide responsive visual feedback during dynamic measurement operations.

The LED panel control electronics may incorporate dedicated display driver circuits that manage the electrical power distribution and timing sequences for individual light-emitting elements within the display matrix. In some cases, the display drivers may utilize constant-current regulation techniques that maintain consistent brightness levels across all LED elements while compensating for variations in forward voltage characteristics. The control circuits may incorporate automatic brightness adjustment capabilities that monitor ambient light conditions and adjust display intensity to maintain optimal visibility while minimizing power consumption. The LED panel control system may provide serial communication interfaces that enable data transfer from the computing system using standardized protocols such as universal asynchronous receiver-transmitter or serial peripheral interface. The power management circuits may implement sleep modes that reduce power consumption during periods of inactivity while maintaining rapid wake-up capabilities when display updates are required.

The information display capabilities of the LED panel may present measurement status, system diagnostics, and operational parameters in formats that enable rapid interpretation by field personnel during thread profiling operations. In some cases, the display may present numerical values representing thread dimensions such as pitch measurements, flank angles, or depth calculations in engineering units appropriate for the measurement application. The LED panel may display progress indicators that show the completion status of measurement scans or calibration procedures to inform operators of system activity and estimated completion times. The status display may include color-coded indicators that provide immediate visual feedback regarding measurement quality, system readiness, or error conditions that require operator attention. The information update frequency may be synchronized with measurement operations to provide real-time feedback regarding system performance and measurement progress.

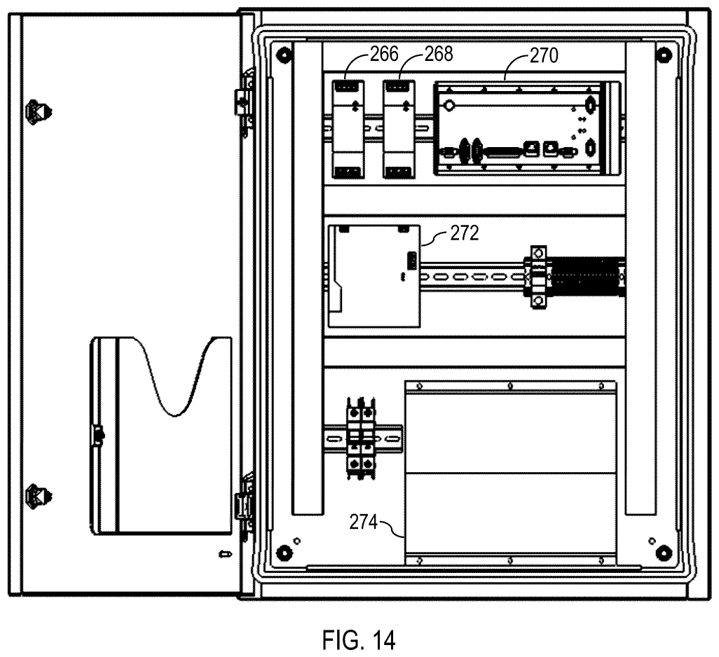

FIG. 14 shows the computing hardware implemented to provide measurement control and data processing. The measurement control and processing is automated to reduce operator dependency and minimize potential for human error. Referring to FIG. 14, the computing hardware includes a first optical sensor power supply 266 and a second optical power supply 268, optical sensor controller 270, uninterruptable power supply 272, and gauge computer 274. In an embodiment, optical sensor controller 270 is a spectrometer controller. The optical sensor power supplies 266 and 268 provide power to optical sensors 222 and 224, respectively. Optical sensor controller 270 is communicatively coupled to optical sensors 222 and 224, for example, by fiber optic cables. Optical sensor controller 270 receives raw optical measurement data from optical sensors 222 and 224 and converts the raw optical measurement data into respective distance measurements along the respective optical axis. In an embodiment, optical sensor controller 270 generates two displacement values each representing a distance between 0 and 3.7 mm or 0 and 4.3 mm, as described above, one for each optical sensor 222 and 224. In an embodiment, optical sensor controller 270 determines the displacement values at 2 kHz. In other embodiments, optical sensor controller 270 determines the displacement values at 25 kHz. The computing hardware is communicatively coupled to the clamping actuator 244, the drive mechanism 240, the displacement sensor 238, the optical sensors 222 and 224, and the LED display panel 210.

Uninterruptable power supply 272 provides short-term power in the event that the main power source is lost. In an embodiment, uninterruptable power supply 272 is a 24-volt capacitor module. This short-term power is utilized to safely shut down the gauge computer. Sudden power loss without uninterruptable power supply 272 raises the likelihood of data and/or hard drive corruption. When a power loss is detected, uninterruptable power supply 272 sends an output signal to the gauge computer 274 indicating that uninterruptable power supply 272 is providing backup power. This signal is used to safely shut down the system.

Optical sensor controller 270 is communicatively coupled to gauge computer 274. In an embodiment, gauge computer 274 is an industrial processor. Gauge computer 274 receives the displacement values from optical sensor controller 270. Gauge computer 274 further receives position values of the observation platform 230 from the displacement sensor 238. Gauge computer 274 further receives calibration data from the optical sensors that is collected when the optical sensors pass over the calibration feature. Gauge computer 274 determines the thread profile based on these received values.

For example, in an embodiment, gauge computer 274 first determines height values (in the vertical direction) for each x-position of the optical sensor. As explained above, the height values are determined by converting the displacement values from the optical sensors and the optical sensor controller into height values by calculating the height based on the hypotenuse value using known angles of the optical sensors, which are determined using the known dimensions of the calibration feature. The height values are calculated for both optical sensors and reconciled to arrive at the correct height value. Because the x-position is known from the displacement sensor (e.g., the optical encoder read head), the (x, y) coordinates can be determined. The (x, y) coordinates along the entire measurement path are combined to form the thread profile.

Because of the information the system gathers through the two optical sensors and the displacement sensor, the system is able to determine additional measurements. As one example, the system can determine thread lockup, which occurs when a lead for one thread flank differs from the lead for the other thread flank. In this situation, the width between two adjoining thread crests is constantly getting smaller or larger as the thread form is traversed. Traditionally, thread lockup has been measured using hard gauging, in which an inspector uses a block of known thickness and moves it through the thread form until the block suddenly locks up when the width of the groove is equal to the block. Traditionally, the inspector then measures from this block to the face of the pipe to get the final measurement. In contrast to the traditional method of measuring thread lockup, the system described herein measures the width of every thread on the pipe and each thread's corresponding distance to the face. The system then fits these measurements to a function, which is then solved for the ideal block width. Thus, even if the system described herein does not find the actual thread width of interest that is equal to the block width, the system is capable of interpolating the function to find the thread lockup value.

As another example, the system is capable of performing error integration. Error integration takes a measured width of a thread and its distance from the face, and then calculates, using the measured lead for both flanks of the thread, a nominal value that is then subtracted from the measured value, leaving an error value. These error values are integrated over each thread, and then subtracted from the ideal nominal given the ideal block width and ideal distance from the face.

The computing hardware may incorporate high-performance computational hardware configured to handle the substantial data throughput generated by the dual spectrometer measurement configuration during thread profiling operations. In some cases, the processing system may utilize multi-core processor architectures with clock speeds exceeding three GHz to provide adequate computational capacity for real-time data analysis. The processor selection may emphasize floating-point computational capabilities to support the trigonometric calculations and coordinate transformations required for spectrometric data processing. The processing system may incorporate dedicated graphics processing units or field-programmable gate arrays to accelerate parallel computational tasks associated with surface profile reconstruction. The memory subsystem may include high-speed random access memory with capacities exceeding sixteen gigabytes to accommodate the temporary storage requirements for raw measurement data. The data processing architecture may utilize solid-state storage devices with read speeds exceeding five hundred megabytes per second to support rapid data transfer operations. The computational resources may be sized to handle sustained data rates of several megabytes per second generated by the high-frequency spectrometric sampling operations. The processing system may incorporate redundant computational elements to ensure measurement reliability in demanding operational environments.

The measurement control and data processing system, which is implemented on the computing hardware, includes data processing capabilities that enable conversion of raw optical sensor information into meaningful thread profile representations.

In an embodiment, thread measurement is initiated by the measurement actuator, which in some embodiments, is a physical button. Clamping is automatically actuated when the capacitive sensors 254 detect that the pipe face is within range of the contact pins by a signal sent to the clamping actuator 244 to cause the system 200 to engage the pipe being measured. A signal is then sent to the drive mechanism 240 to initiate a measurement pass. The measurement pass begins with the drive mechanism 240 causing the observation platform 230, where the optical sensors 222 and 224 are mounted, to travel the length of the threaded region of the pipe along the longitudinal axis of the threaded region. As the observation platform 230 traverses the longitudinal axis, raw data from the displacement sensor 238 is sent to the computing system. The computing system processes the raw data from the displacement sensor 238 to determine the x-coordinates of the optical sensors 222 and 224 as they move. During this pass, the optical sensors 222 and 224 pass over the calibration feature 264. Raw optical measurement data is sent from the optical sensors 222 and 224 to the computing system. The computing system processes the raw optical measurement data and the x-coordinates together with the known characteristics of the calibration feature 264 to generate calibration data. As the optical sensors 222 and 224 continue past the calibration feature 264 to the threaded region of the pipe, raw optical measurement data is sent from the optical sensors 222 and 224 to the computing system. The computing system processes the raw optical measurement data and the x-coordinates together with the newly generated calibration data to generate a thread profile of the threaded region of the pipe. This process continues until the optical sensors reach the end of the threaded region of the pipe. The computing system then compares the generated thread profile against quality control parameters for the pipe being measured to determine whether the thread profile meets the relevant requirements.

The computing system may perform the data processing described herein in real-time during measurement operations or through post-processing of stored measurement data. The computational resources may be sized to handle the high data rates generated by the optical sensors during measurement operations.

In some cases, the raw data processing may require floating-point operations at rates exceeding one hundred million calculations per second to maintain real-time processing capabilities. The raw data stage may generate intermediate data files with sizes ranging from several megabytes to hundreds of megabytes depending on the scanning range and sampling frequency. The data processing may incorporate error detection routines that identify and flag anomalous data points or signal quality issues during the raw data acquisition phase.

The coordinate conversion stage may transform the conditioned spectrometric data into spatial coordinate representations that correspond to the two-dimensional geometry of the threaded surface being measured. In some cases, the coordinate conversion process may apply trigonometric transformations that account for the angular positioning of each spectrometer relative to the measurement surface. The conversion algorithms may utilize calibration data obtained from the integrated calibration feature to correct for angular deviations or alignment errors in the positioning of the optical sensors. The coordinate transformation may generate x-coordinate values that represent longitudinal position along the threaded pipe axis and y-coordinate values that represent radial height variations of the thread profile. The computational processing may involve matrix multiplication operations that combine measurement data from both optical sensors to reconstruct comprehensive surface profile information. The coordinate conversion stage may apply interpolation algorithms that generate continuous surface representations from discrete measurement points captured during the scanning process. The processing may incorporate coordinate system transformations that align the measurement data with standard thread specification reference frames. The coordinate conversion operations may require computational throughput levels exceeding fifty million floating-point operations per second to maintain processing speeds compatible with the measurement data acquisition rates. The resulting coordinate data may be formatted in arrays containing thousands to millions of data points depending on the thread length and measurement resolution requirements.

The analysis stage may compare the converted coordinate data against predetermined thread specification parameters to evaluate dimensional compliance and identify potential defects or irregularities in the threaded connection. In some cases, the analysis algorithms may calculate thread pitch values by measuring the longitudinal spacing between corresponding points on adjacent thread crests or roots. The dimensional analysis may determine thread flank angles by computing the slopes of the thread surfaces using linear regression techniques applied to the coordinate data. The analysis processing may calculate thread depth measurements by determining the radial distance between thread crests and roots along the profile geometry. The computational analysis may evaluate thread form accuracy by comparing measured profile shapes with theoretical thread geometries defined in applicable standards. The analysis stage may incorporate statistical processing routines that calculate measurement uncertainties and confidence intervals for the dimensional parameters. The defect detection algorithms may identify surface irregularities such as scratches, gouges, or material buildup that could affect thread performance. The analysis processing may generate pass-fail determinations based on comparison of measured dimensions with specified tolerance limits. The computational requirements for the analysis stage may involve complex mathematical operations including curve fitting, statistical analysis, and pattern recognition algorithms that require processing capabilities measured in billions of operations per second.

The computational architecture may utilize parallel processing techniques to distribute the data processing workload across multiple processor cores or specialized computational units to achieve the throughput requirements for real-time thread analysis. In some cases, the parallel processing implementation may assign different stages of the data processing pipeline to separate computational threads that execute simultaneously on different processor cores. The task distribution may allocate raw data conditioning operations to dedicated signal processing units while coordinate conversion and analysis functions execute on general-purpose processor cores. The parallel architecture may incorporate data buffering systems that enable continuous data flow between processing stages while accommodating variations in computational processing times. The load balancing algorithms may dynamically adjust the computational resource allocation based on the complexity of the measurement data and the processing requirements of each analysis stage. The parallel processing system may utilize shared memory architectures that enable efficient data transfer between computational elements without introducing significant latency delays. The synchronization mechanisms may ensure that data processing operations maintain proper temporal relationships and avoid race conditions that could compromise measurement accuracy. The parallel computational approach may achieve overall processing throughput levels that exceed the data generation rates of the spectrometric measurement system by factors of two to five times.

The memory management system may optimize data storage and retrieval operations to support the high-throughput requirements of the multi-stage data processing approach while minimizing latency delays that could affect real-time processing capabilities. In some cases, the memory architecture may utilize hierarchical storage systems that place frequently accessed data in high-speed cache memory while archiving processed results in slower but higher-capacity storage devices. The memory allocation algorithms may dynamically assign memory resources based on the current processing stage and the size of the measurement datasets being analyzed. The data buffering systems may implement circular buffer architectures that enable continuous data acquisition while previous measurement data undergoes processing and analysis. The memory management may incorporate garbage collection routines that automatically reclaim memory resources from completed processing operations to prevent memory exhaustion during extended measurement sessions. The storage optimization may utilize data compression techniques that reduce memory requirements while preserving the precision of the measurement information. The memory system may incorporate error correction capabilities that detect and correct single-bit errors that could occur in the stored measurement data. The memory bandwidth requirements may exceed several gigabytes per second to support the simultaneous data transfer operations required by the parallel processing architecture. The memory management system may provide data persistence capabilities that preserve measurement results and processing parameters across system power cycles or operational interruptions.

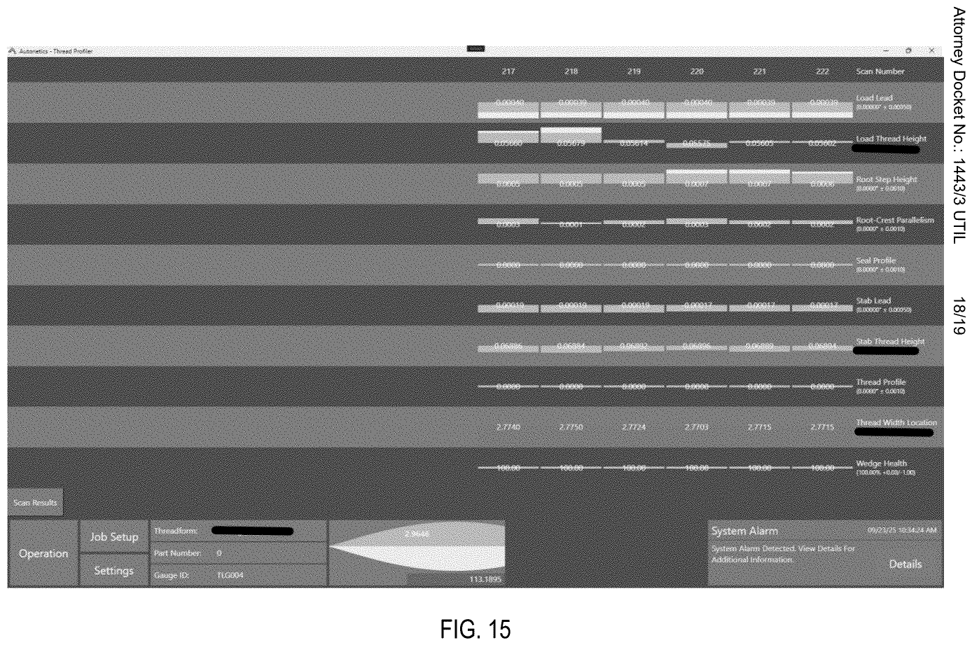

FIG. 15 shows a graphical user interface on a remote computer. Referring to FIG. 15, in an embodiment, the graphical user interface displays load lead values, load thread height values, root step height values, root-crest parallelism values, seal profile values, stab lead values, stab thread height values, thread profile values, thread width location, and wedge health (measured as a percentage) for one or more scans. The graphical user interface on the remote computer enables advanced data visualization, analysis, and system control capabilities that extend beyond the limitations of the integrated LED panel display. In some cases, the graphical user interface may be provided on a remote computer utilizing wireless communication protocols such as wireless fidelity or Bluetooth to establish data connections with laptop computers, tablet devices, or desktop workstations located within communication range of the measurement system. The graphical user interface presents comprehensive visualization and analysis tools that enable detailed examination of thread profile measurements and system performance data. In some cases, the graphical user interface displays two-dimensional representations of measured thread profiles that enable visual inspection of thread geometry from multiple viewing angles and perspectives. The graphical user interface may provide interactive measurement tools that enable operators to perform dimensional analysis, tolerance checking, and comparison operations using point-and-click or touch-screen interaction methods. The graphical user interface may present measurement data in various formats including cross-sectional views, surface plots, and statistical charts that facilitate different types of analysis and documentation requirements. The graphical user interface may incorporate zoom and pan capabilities that enable detailed examination of specific thread features or regions of interest within the measured profile data. The graphical user interface may provide overlay capabilities that enable comparison of measured thread profiles with theoretical reference geometries or previous measurement results from the same threaded component. Additionally, the graphical user interface may generate printable reports that include measurement results, graphical representations, and statistical analysis in formats suitable for quality documentation or regulatory compliance requirements. The graphical user interface may incorporate customizable display preferences that enable operators to configure screen layouts, color schemes, and information presentation formats according to individual preferences or organizational standards. The graphical user interface may provide real-time display updates that show measurement progress and results as data becomes available from the measurement system.

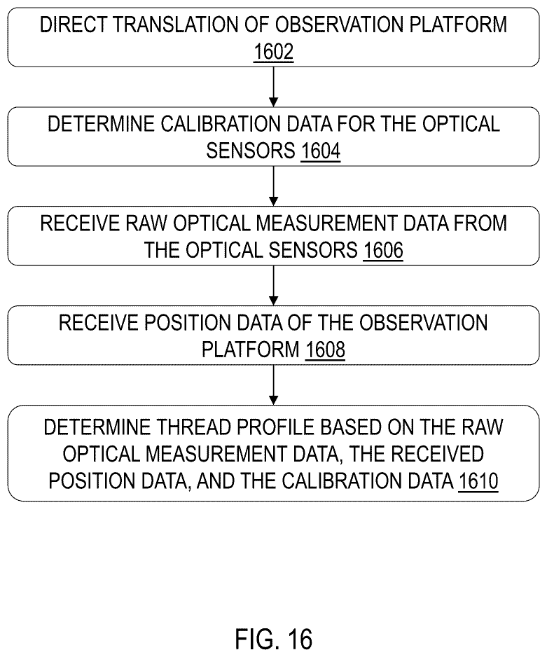

FIG. 16 shows an example method for determining the thread profile using the portable optical thread-profiling system. Referring to FIG. 16, the method is for determining the thread profile may be performed by one or more hardware processors, including, for example, the optical sensor controller and/or the gauge computer. As shown in step 1602, the system begins a measurement pass by directing translation of the observation platform. This may be accomplished, for example, by sending a signal to the drive mechanism to cause the drive mechanism to move (e.g., translate along the longitudinal axis) the observation platform. In an embodiment, the measurement pass may be initiated in response to the user pressing or selecting the measurement actuator. In an embodiment, the measurement pass may be initiated automatically when the capacitive sensors detect the pipe face in the correct position, which also causes the clamping actuator to engage the pipe. As shown in step 1604, the system determines calibration data for the optical sensors. This is done by performing one or more calibration routines in which the measurements taken for the calibration feature from the optical sensors and measurements from the displacement sensor are combined to determine, for example, the angle and the location of the optical sensors and the displacement sensor. These measured values are used to determine calibration data which can then be used for calibration of the optical sensors. As shown in step 1606, the system receives raw optical measurement data from the optical sensors. In an embodiment, the raw optical measurement data is received through fiber optic cables electrically connected to the optical sensors. The raw optical measurement data may be provided continuously in real-time or near real-time during the measurement pass. In an embodiment, the raw optical measurement data is converted, for example, by the optical sensor processor into a distance value. The distance value may be a numerical value representing distance along the optical axis, or the distance value may be a value that has been converted, as described above, into a vertical (or y) value. As shown in step 1608, the system receives position data of the observation platform from the displacement sensor. In an embodiment, the position data is received through an electrical or fiber optic cable electrically connected to the optical encoder read head. The position data may be provided continuously in real-time or near real-time during the measurement pass. As shown in step 1610, the system determines a thread profile based on the raw optical measurement data, the received position data, and the calibration data. In an embodiment, the optical sensor processor and/or the gauge computer receives the raw optical measurement data, the received position data, and the calibration data, and algorithmically determines the thread profile, for example, by using the calibration data to determine the appropriate adjustments to make to the raw optical measurement data and/or the position data. Once the appropriate adjustments have been made, the position data and the raw optical sensor data is combined to generate (x, y) coordinates of the thread profile. These (x, y) coordinates are used to determine the thread profile. From the thread profile, the various values displayed on the graphical user interface can be determined or calculated.

The ultra-high resolution measurement capabilities may be achieved through the coordinated operation of all system components working in concert to minimize measurement uncertainties and maximize spatial resolution of thread profile characterization. In some cases, the resolution enhancement may be accomplished through oversampling techniques that capture surface profile data at spatial intervals significantly smaller than the optical spot sizes of individual optical sensors. The integrated system may achieve measurement resolution levels approaching sub-micron accuracy through statistical averaging of multiple measurement samples and application of advanced signal processing algorithms. The ultra-high resolution operation may require computational processing capabilities that handle data rates exceeding several megabytes per second while maintaining real-time coordinate transformation and dimensional analysis. The measurement accuracy may be verified through comparison with coordinate measuring machines or optical measurement systems with traceable accuracy characteristics. The integrated system performance may be maintained through comprehensive calibration procedures that account for all sources of measurement uncertainty including optical aberrations, mechanical positioning errors, and environmental effects. The ultra-high resolution capabilities may enable detection of surface features and dimensional variations that would not be measurable using conventional thread inspection methods. The coordinated system operation may provide measurement repeatability levels that support statistical process control applications and quality assurance requirements in precision manufacturing environments.

The foregoing description of embodiments is provided to enable those skilled in the art to make and use the subject matter described herein, and is not intended to limit the scope of the subject matter in any manner. Various modifications, alternatives, and equivalents will be apparent to those skilled in the art, and the principles disclosed may be applied to other embodiments without departing from the scope of the claims. Accordingly, the scope of protection should be determined only by the appended claims and their full range of equivalents.

What is claimed is:

1. A portable optical thread-profiling system, comprising:
a clamping assembly configured to engage a portion of a pipe having a threaded region;
a movement stage disposed above an outer surface of the pipe when the portion of the pipe is engaged by the clamping assembly, wherein the movement stage comprises:
a moveable observation platform configured to translate along a longitudinal axis of the threaded region of the pipe, wherein the observation platform comprises:
a first optical sensor disposed along the longitudinal axis at a forward angle relative to the outer surface of the pipe;
a second optical sensor disposed along the longitudinal axis at a rearward angle relative to the outer surface of the pipe; and
a displacement sensor configured to measure a position of the observation platform along the longitudinal axis; and
a drive mechanism configured to translate the observation platform along the longitudinal axis.

2. The portable optical thread-profiling system of claim 1, further comprising one or more hardware processors configured for performing a measurement pass to measure a thread profile of the threaded region of the pipe, wherein the measurement pass comprises:
directing translation of the observation platform along the longitudinal axis;
receiving raw optical measurement data from the first optical sensor and the second optical sensor during the translation of the observation platform;
receiving position data of the observation platform from the displacement sensor during the translation of the observation platform; and
determining a thread profile of the threaded region of the pipe based on the received raw optical measurement data, the received position data, and calibration data for the first optical sensor and the second optical sensor.

3. The portable optical thread-profiling system of claim 2, wherein the one or more hardware processors are further configured for converting the raw optical measurement data from the first optical sensor and the second optical sensor into coordinate data in an (x, y) format.

4. The portable optical thread-profiling system of claim 2, wherein the raw optical measurement data from the first optical sensor is a numerical value that represents a distance from the first optical sensor to the surface of the pipe along an optical axis of the first optical sensor, and the raw optical measurement data from the second optical sensor is a numerical value that represents a distance from the second optical sensor to the surface of the pipe along an optical axis of the second optical sensor.

5. The portable optical thread-profiling system of claim 2, wherein the one or more hardware processors are further configured for comparing the determined thread profile against one or more expected parameters of the threaded region of the pipe.

6. The portable optical thread-profiling system of claim 2, wherein the calibration data for the first optical sensor and the second optical sensor is determined based on a calibration routine performed using a calibration feature.

7. The portable optical thread-profiling system of claim 2, wherein the one or more hardware processors are further configured for determining, based on the received raw optical measurement data, the received position data, and calibration data, one or more of the following values for the threaded region of the pipe: load lead value, load thread height value, root step height value, root-crest parallelism value, seal profile value, stab lead value, stab thread height value, thread profile value, thread width location, and wedge health (measured as a percentage) for one or more scans.

8. The portable optical thread-profiling system of claim 1, wherein the movement stage further comprises a calibration feature aligned with an optical measurement path of the first optical sensors and the second optical sensor.

9. The portable optical thread-profiling system of claim 8, wherein the calibration feature comprises a known thread pattern that allows the system to determine an angle of the first optical sensor and the second optical sensor during the measurement pass.

10. The portable optical thread-profiling system of claim 8, further comprising one or more hardware processors configured for performing a measurement pass to measure a thread profile of the threaded region of the pipe, wherein the measurement pass comprises:
directing translation of the observation platform along the longitudinal axis;
performing a calibration routine to determine calibration data for the first optical sensor and the second optical sensor as said optical sensors pass over the calibration feature during the translation of the observation platform;
receiving raw optical measurement data from the first optical sensor and the second optical sensor during the translation of the observation platform;
receiving position data of the observation platform from the displacement sensor during the translation of the observation platform; and
determining a thread profile of the threaded region of the pipe based on the received raw optical measurement data, the received position data, and the determined calibration data.

11. The portable optical thread-profiling system of claim 10, wherein the calibration routine is performed during each measurement pass.

12. The portable optical thread-profiling system of claim 1, wherein the clamping assembly comprises:
an internal clamping surface configured for insertion into the end portion of the pipe; and
a clamping actuator configured for moving the internal clamping surface to engage an inner surface of the pipe.

13. The portable optical thread-profiling system of claim 1, wherein the first optical sensor and the second optical sensor are confocal spectrometer probes electronically coupled to a spectrometer controller by fiber optic cables.

14. The portable optical thread-profiling system of claim 1, wherein the forward angle of the first optical sensor is approximately 45° from perpendicular to the outer surface of the pipe, and the rearward angle of the second optical sensor is approximately 45° from perpendicular to the outer surface of the pipe, such that the first optical sensor and the second optical sensor are positioned approximately 90° relative to one another.

15. The portable optical thread-profiling system of claim 1, wherein the first optical sensor and the second optical sensor sample at a minimum frequency of 25 kHz.

16. The portable optical thread-profiling system of claim 1, wherein the displacement sensor comprises an optical encoder read head configured to read position data from an encoder strip on the movement stage.

17. The portable optical thread-profiling system of claim 1, further comprising a face assembly connected to the movement stage, wherein the face assembly comprises a display panel.

18. The portable optical thread-profiling system of claim 1, wherein the movement stage further comprises a first rail and a second rail, wherein the observation platform further comprises a first carriage and a second carriage, and wherein the first carriage slidably engages the first rail, and the second carriage slidably engages the second rail to allow for the observation platform to translate along the longitudinal axis.

19. A method for measuring a thread profile of a pipe having a threaded region using a portable optical thread-profiling system, comprising:
engaging an end portion of the pipe;
directing translation of an observation platform of the portable optical thread-profiling system along a longitudinal axis of the threaded region of the pipe, wherein the observation platform comprises a first optical sensor disposed at a forward angle relative to an outer surface of the pipe and a second optical sensor disposed at a rearward angle relative to the outer surface of the pipe;
receiving raw optical measurement data representing the thread profile from the first optical sensor and the second optical sensor during the translation of the observation platform;
receiving position data of the observation platform from a displacement sensor of the portable optical thread-profiling system during the translation of the observation platform; and
determining a thread profile of the threaded region of the pipe based on the received raw optical measurement data, the received position data, and calibration data for the first optical sensor and the second optical sensor.

20. A non-transitory computer-readable storage medium, the non-transitory computer-readable storage medium storing instructions to be implemented on a portable optical thread-profiling device comprising:
a clamping assembly configured to engage a portion of a pipe having a threaded region;
a movement stage disposed above an outer surface of the pipe when the portion of the pipe is engaged by the clamping assembly, wherein the movement stage comprises:
a moveable observation platform configured to translate along a longitudinal axis of the threaded region of the pipe, wherein the observation platform comprises:
a first optical sensor disposed along the longitudinal axis at a forward angle relative to the outer surface of the pipe;
a second optical sensor disposed along the longitudinal axis at a rearward angle relative to the outer surface of the pipe; and
a displacement sensor configured to measure a position of the observation platform along the longitudinal axis; and
a drive mechanism configured to translate the observation platform along the longitudinal axis;
at least one hardware processor electronically connected to the portable optical thread-profiling device;
the instructions when executed by the at least one hardware processor cause portable optical thread-profiling device to perform a measurement pass to measure a thread profile of the threaded region of the pipe, wherein the measurement pass comprises:
directing translation of the observation platform along the longitudinal axis;
receiving raw optical measurement data from the first optical sensor and the second optical sensor during the translation of the observation platform;
receiving position data of the observation platform from the displacement sensor during the translation of the observation platform; and
determining a thread profile of the threaded region of the pipe based on the received raw optical measurement data, the received position data, and calibration data for the first optical sensor and the second optical sensor.
